(19) United States
(12) Patent Application Publication
(10) Pub. No.: US 2006/0192913 A1
(43) Pub. Date: Aug. 31, 2006

(54) Phase difference film and production method therefor

(76) Inventors: Shunsuke Shutou, Osaka (JP); Hiroaki Kobayashi, Osaka (JP); Takuya Matsunaga, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/544,208

(22) PCT Filed: Jan. 26, 2004
(86) PCT No.: PCT/JP04/00667

§ 371 Date: Apr. 20, 2006

(30) Foreign Application Priority Data
Feb. 3, 2003 (JP) 200325961

(51) Int. Cl. G02F 1/1335

(52) U.S. Cl. 349/117

(57) ABSTRACT

A retardation film that has an optical retardation layer whose alignment direction is controlled precisely and that is produced at a low cost, and also a method for producing the same, are provided. The explanation below relates to FIG. 1. First, a base-attached anisotropic layer 12 is prepared by laminating an optically anisotropic layer 11 on a transparent base 10. Next, on the optically anisotropic layer 11, a solution containing a polymer reacting with polarized ultraviolet light and a liquid crystalline compound is coated and dried. Then, it is irradiated with polarized ultraviolet light so as to align the liquid crystalline compound, and irradiated further with unpolarized ultraviolet light as required to crosslink the liquid crystalline compound, thereby forming a retardation film 1 having an optical retardation layer 13 that is directly formed on the optically anisotropic layer 11.

### TECHNICAL FIELD

The present invention relates to a retardation film that is used preferably for an image display apparatus such as a liquid crystal display (LCD) or the like, and a method for producing the same.

### BACKGROUND ART

A retardation film (called also an optically compensation film, a compensation sheet and the like) is an important member for realizing an improvement in contrast and enlargement of a viewing angle range by means of an optical compensation in an image display apparatus such as a liquid crystal display.

Recently, in an optical compensation using the retardation film, for further improved compensation, techniques of laminating plural layers having optical axes directions that are different from each other have been proposed often. For example, it is reported that for particularly compensating a viewing angle of a LCD used for an airplane part, use of an A-plate retardation film and an O-plate retardation film in a superimposed state is effective (see U.S. Pat. No. 6,266,114). Furthermore, it is also proposed to compensate a viewing angle of a LCD by a combined lamination of an A-plate, an O-plate and a C-plate (see U.S. Pat. No. 5,504,603). Another literature proposes a compensation sheet (retardation film) formed by laminating a compensation layer (retardation layer) of a liquid crystalline compound via an optically aligned film (see JP 2002-14233 A). The A-plate, C-plate and O-plate denote layers each having a so-called uniaxial optical anisotropy. The A-plate is called a positive A-plate when the optical axis exists in the in-plane direction and the optical characteristics meet the condition of Formula (I) below, and called a negative A-plate when the optical characteristics meet the condition of Formula (II) below.
nx>ny=nz (I)
nx<ny=nz (II)

The C-plate has an optical axis that exists in a thickness direction perpendicular to the in-plane direction. It is called a positive C-plate when the optical characteristics meet the condition of Formula (III) below and called a negative C-plate when the optical characteristics meet the condition of Formula (IV) below.
nx=ny<nz (III)
nx=ny>nz (IV)

In the above Formulae (I)-(IV), nx, ny and nz denotes refractive indices in X-, Y- and Z-axes directions in the layer. Here, either the X-axis or the Y-axis denotes an axial direction exhibiting a maximum refractive index within the plane of the layer, and the other denotes an axial direction within the plane perpendicular to the axis. The Z-axis denotes a thickness direction perpendicular to the X-axis and the Y-axis. And in the above-mentioned O-plate, the optical axis direction is inclined when viewed from the in-plane direction and from the Z-axis direction (a thickness direction perpendicular to the in-plane direction).

For superimposing the plural layers, plural retardation films can be used, or the plural layers can be laminated on a single retardation film. The latter method is preferred for decreasing the thickness of the liquid crystal display. The retardation film can be, for example, a stretched film provided with a refractive index anisotropy by stretching, and a coating film that is prepared by coating a liquid crystalline compound on a film and aligning. Recently, there has been a keen demand for further reduction of thickness and improved functions of the liquid crystal display, and particularly, the development of a coating film including an optically anisotropic layer and at least one retardation layer has raised interest.

In the coating film, for forming an optical retardation layer including a liquid crystalline compound, the liquid crystalline compound must be aligned in a particular axial direction. Examples of methods for this purpose include a method of using an alignment film (see JP 2002-14233 A, for example) and a method of using an alignment substrate.

An example of a method of using an alignment film is described below briefly. First, a base having an optically anisotropic layer formed on the surface is prepared. For this base, for example, a transparent and optically isotropic polymer film or the like can be used. Next, a liquid for forming an alignment film is coated on the optically anisotropic layer so as to form a smooth film. The film is subjected to further treatments such as rubbing and irradiation in order to provide a liquid crystal alignment restraining force, thereby forming an alignment film. On the alignment film, a solution or melt of a liquid crystalline compound or the like is coated to form an optical retardation layer. When laminating two or more optical retardation layers, a liquid for forming an alignment film is coated further on the optical retardation layer, and operations as mentioned above are repeated for forming the alignment film and the optical retardation layer.

According to this method, a series of steps of forming an alignment film is required every time an optical retardation layer is formed, and every time treatments such as rubbing and irradiation must be carried out. For this reason, more materials and more processes are required, and the production cost will be raised. Furthermore, since the optically anisotropic layer is composed of a polymer compound, it can be corroded easily by an organic solvent or the like contained in the liquid used for formation of the alignment film. As a result, even when a liquid for formation of an alignment film is applied, the liquid may penetrate into the optically anisotropic layer, and lose its functions for the alignment films.

A method of using an alignment substrate will be summarized below. First, an alignment substrate having an optical anisotropy is prepared. Next, a solution or a melt of a liquid crystalline compound is coated on the surface so as to form an optical retardation layer. Separately, a base having an optically anisotropic layer formed on the surface is prepared. For the base, a transparent and optically isotropic polymer film is used, for example. Next, an adhesive is applied onto the optically anisotropic layer. Subsequent to bonding the optical retardation layer and the adhesive, the alignment substrate is removed (hereinafter, this operation may be referred to as “transferring”). For laminating two or more optical retardation layers, a further adhesive is applied onto the optical retardation layer and a separately prepared retardation layer is transferred further onto the surface.

However, a step of coating a liquid crystalline compound on an alignment substrate and a step of transferring are required every time an optical retardation layer is formed in this method, and thus the process for producing a retardation film may be complicated and the cost may be raised. Moreover, since alignment layers different from each other in the alignment property must be prepared for the respective optical retardation layers, the cost for the materials will be raised as well. For the alignment substrate, a stretched plastic film such as a polyethylene terephthalate film are used typically from an aspect of the cost or the like. However, this may lead to a difficulty in an arbitrary control of the alignment of the liquid crystalline compounds.

As mentioned above, the method of using an alignment film or an alignment substrate may increase both the production steps and the material cost. The alignment film, the adhesive or the like are unnecessary from an aspect of optical functions of the retardation film, and thus they are preferably omitted for decreasing the thickness of the film.

Techniques for aligning a liquid crystal without using an alignment film or an alignment substrate, particularly methods of using polarized ultraviolet light, have been reported (see for example, JP 2002-517605 A; Kawatsuki et al., Jpn. J. Phys., 2002, Vol. 41, p. 198-200). An example of such disclosures is a method for producing a liquid crystal alignment layer by using a mixture of a linear photopolymerization polymer and a photopolymerization liquid crystal monomer. In this method, the mixture is coated on a glass plate first, then irradiated with polarized ultraviolet light so that the polymer is polymerized. Then, the liquid crystal monomer is cured with unpolarized ultraviolet light, and thus a liquid crystal alignment layer having an alignment parallel to a polarization face of the polarized ultraviolet light is obtained (see JP 2002-517605 A). In an alternative method, a mixture of a photoreactive liquid crystal polymer and a liquid crystal monomer is irradiated with polarized ultraviolet light, then heat-treated to obtain a liquid crystal alignment layer (see Kawatsuki et al., Jpn. J. Phys., 2002, Vol. 41, p. 198-200).

However, each of these liquid crystal alignment layers is formed alone on a glass plate, but it is not produced as an optical retardation layer on a film. Furthermore, any of the liquid crystal alignment layers is formed as a monolayer, while there have been no examples of forming an optical retardation layer on an optically anisotropic layer, or laminating two or more of the optical retardation layers.

### DISCLOSURE OF INVENTION

Therefore, an object of the present invention is to provide a retardation film that has an optical retardation layer whose alignment direction is under a precise control and that can be produced at a low cost, and a method for producing the same.

For attaining the above-described object, a retardation film of the present invention includes an optically anisotropic layer and an optical retardation layer, and the optical retardation layer includes a liquid crystalline compound, wherein the optical retardation layer is laminated directly on the optically anisotropic layer.

### BRIEF DESCRIPTION OF DRAWINGS

FIG. 1 is a longitudinal cross-sectional view showing a retardation film in Example 1.

FIG. 2 is a schematic view showing irradiation of polarized ultraviolet light in Example 1.

FIG. 3 is a perspective view of a retardation film in Example 2.

FIG. 4 is a longitudinal cross-sectional view showing a retardation film in Comparative Example 1.

FIG. 5 is a perspective view of a retardation film in Comparative Example 2.

FIG. 6 is a schematic view showing polarimetry.

FIG. 7 is a graph showing a relationship between a retardation and a gate angle in a retardation film in Example 1.

FIG. 8 is a graph showing a relationship between a retardation and a gate angle in a retardation film in Example 2.

FIG. 9 is a graph showing a relationship between a retardation and a gate angle in a retardation film in Comparative Example 1.

FIG. 10 is a graph showing a relationship between a retardation and a gate angle in a retardation film in Comparative Example 2.

### DESCRIPTION OF THE INVENTION

Embodiments of the present invention will be described below.

Since a retardation film of the present invention is formed by laminating an optical retardation layer directly on an optically anisotropic layer without interposing either an alignment film or an adhesive, costs can be reduced for materials for the alignment film or for the adhesive. Moreover, the thickness of the optical retardation layer can be decreased for the alignment film, the adhesive or the like. In the present invention, the term “retardation layer” denotes any of optically anisotropic layers, which is laminated directly on another optically anisotropic layer and includes an aligned liquid crystalline compound.

As mentioned above, the retardation film of the present invention includes an optically anisotropic layer and an optical retardation layer as main constituent elements. First, the optical retardation layer will be described below.

In a retardation film of the present invention, the number of the optical retardation layer is not limited to one but a plurality of optical retardation layers can exist. It is preferable that the respective optical retardation layers are laminated directly without interposing alignment layers, adhesives or the like. The number of the optical retardation layers will not be limited particularly, but it can be selected arbitrarily in accordance with a liquid crystal cell or the like of a liquid crystal display in which the optical retardation layer will be packaged.

The liquid crystalline compound to be contained in the optical retardation layer is not limited particularly, but for example, a rod-like liquid crystalline compound, a planar liquid crystalline compound, polymers thereof or the like can be used. A kind of liquid crystalline compound can be used alone or it can be mixed with at least one of the other liquid crystalline compounds. As for a polymer, it can be either a homopolymer or a heteropolymer (copolymer). The polymer can retain its liquid crystal property or it can lose the liquid crystal property due to polymerization or crosslinking. It is preferable that the liquid crystalline compound has a crosslinking structure since the alignment state is fixed by the crosslinking structure and thus it is stable with respect to heat. It is also preferable that the liquid crystalline compound contains a nematic liquid crystalline compound because the alignment will be improved and the alignment defects will be decreased.

Specific examples that can be used for the liquid crystalline compound include liquid crystalline compounds of azomethines, azoxys, cyanobiphenyls, cyanophenyl esters, benzoates, cyclohexane carboxylic acid phenyl esters, cyanophenyl cyclohexanes, cyano-substituted phenylpyrimidines, alkoxy-substituted phenylpyrimidines, phenyldioxanes, tolans, and alkenylcyclohexylbenzonitriles, and polymers thereof.

The alignment direction of the liquid crystalline compound is not limited particularly, but it can be set suitably for obtaining an optimum optical compensation. For example, for achieving a preferable viewing angle properties in a liquid crystal cell of a twist nematic (TN) type liquid crystal display or an OCB type liquid crystal display, the alignment direction is inclined preferably with respect to the face direction of the optically anisotropic layer. Examples of the alignment state include a so-called homogeneous tilt alignment and hybrid alignment. Among them, from a view of display characteristics and easiness in production or the like, the hybrid alignment is preferred, where the inclination angle of the liquid crystalline compound varies continuously depending on the position of the optical retardation layer in the thickness direction. Furthermore, it is preferable for obtaining a favorable viewing angle compensation that a vector component in a face direction of the optically anisotropic layer, which composes a vector in the alignment direction of the liquid crystalline compound, crosses at right angles an optical axis of the optically anisotropic layer. The alignment state where the alignment direction of the liquid crystalline compound varies depending on the position of the optical retardation layer in the thickness direction includes a so-called chiral nematic alignment and the like as well as the above-mentioned hybrid alignment. For obtaining a favorable viewing angle compensation in a VA type liquid crystal display, a chiral nematic alignment or the like is preferred. In addition, in accordance with the kinds of the image display apparatuses, preferred alignment states can be selected suitably. For example, a so-called homogenous alignment and a homeotropic alignment can be applied.

It is preferable that the optical retardation layer further includes an aligned polymer so that the alignment direction of the liquid crystalline compound can be held easily. The ratio of the liquid crystalline compound to the polymer is not limited particularly, and it varies depending on the kinds of the materials. The ratio can be selected suitably, by considering the performance of the optical retardation layer and the convenience in production. Furthermore, the optical retardation layer can include suitably any materials other than the above-mentioned liquid crystalline compound and the polymer, in a range not hindering the functions.

Furthermore, the optical characteristics of the optical retardation layer are not limited particularly and it can be set suitably to obtain an optimum optical compensation. For example, it preferably has a positive uniaxial refractive index anisotropy.

Next, the optically anisotropic layer will be described below.

The type of the optically anisotropic layer is not limited particularly but it can be selected suitably in accordance with the kind of an image display apparatus to which the retardation film of the present invention is applied, a liquid crystal cell or the like of a liquid crystal display. For example, it can be selected from a stretched film of a polymer compound, a coating film or the like. The coating film is, for example, formed on a transparent and optically isotropic polymer film, and used.

Though there is no particular limitation, the stretched film preferably contains a thermoplastic polymer, and the thermoplastic polymer can be used alone or as a mixture of at least two kinds of thermoplastic polymers. For the thermoplastic polymer, for example, polyolefin (polyethylene, polypropylene etc.), polynorbornene-based polymer, polyester, polyvinyl chloride, polystyrene, polyacrylonitrile, polysulfone, polyarylate, polyvinyl alcohol, polymethacrylate, polyacrylic ester, cellulose ester and the copolymers can be used. Another example is a polymer described in JP 2001-343529 A (WO 01/37007). The material is a resin composition containing a thermoplastic resin whose side chain has a substituted or unsubtituted imido group and a thermoplastic resin whose side chain has a substituted or unsubtituted phenyl group and cyano group. More specifically, a resin composition containing an alternating copolymer of isobutene and N-methylmaleimide and an acrylonitrile-styrene copolymer can be used. Then polymer film can be formed by extruding the resin composition.

For the materials for forming the coating film, for example, various polymer compounds, liquid crystalline compounds or the like can be used, and such a compound can be used alone or as a mixture of at least two kinds of the compounds. Though there is no particular limitation for the kinds or the alignment state or the like of the liquid crystalline compounds, for example, substantially they are the same as those of the optical retardation layer. Though there is no particular limitation for the polymer compounds, for example, polyamide, polyimide, polyester, poly(etherketone), poly(amide-imide), poly(ester-imide) and the like can be used. Here, poly(etherketone), poly(amide-imide) and poly(ester-imide) denote, respectively, a polymer compound containing an ether bond and a carbonyl group, a polymer compound containing an amide bond and an imide bond, and a polymer compound containing an ester bond and an imide bond. Hereinafter, these polymer compounds will be described below more specifically.

For example, the polyimide has a high in-plane alignment property and a solublility in an organic solvent. For example, it is possible to use a condensation polymer of 9,9-bis(aminoaryl)fluorene and an aromatic tetracarboxylic dianhydride disclosed in JP 2000-511296 A, and more specifically, a polymer containing at least one repeating unit represented by the formula (1) below.

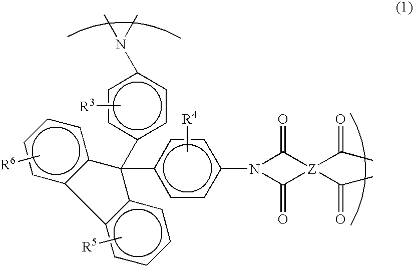

In the above formula (1), R³ to R⁶ are each at least one substituent selected independently from the group consisting of hydrogen, halogen, a phenyl group, a phenyl group substituted with 1 to 4 halogen atoms or a C₁₋₁₀ alkyl group, and a C₁₋₁₀ alkyl group. Preferably, R³ to R⁶ are each at least one substituent selected independently from the group consisting of halogen, a phenyl group, a phenyl group substituted with 1 to 4 halogen atoms or a C₁₋₁₀ alkyl group, and a C₁₋₁₀ alkyl group.

In the above formula (1), Z is, for example, a C₆₋₂₀ quadrivalent aromatic group, and preferably is a pyromellitic group, a polycyclic aromatic group, a derivative of a polycyclic aromatic group or a group represented by the formula (2) below.

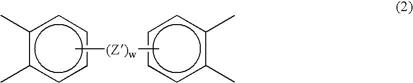

In the formula (2) above, Z′ is, for example, a covalent bond, a C(R⁷)₂ group, a CO group, an O atom, an S atom, an SO₂ group, an Si(C₂H₅)₂ group or an NR⁸ group. When there are plural Z's, they may be the same or different. Also, w is an integer from 1 to 10. R⁷s independently are hydrogen or C(R⁹)₃. R⁸ is hydrogen, a C₁₋₂₀ alkyl group or a C₆₋₂₀ aryl group, and when there are plural R⁸s, they may be the same or different. R⁹s independently are hydrogen, fluorine or chlorine.

The above-mentioned polycyclic aromatic group may be, for example, a quadrivalent group derived from naphthalene, fluorene, benzofluorene or anthracene. Further, a substituted derivative of the above-mentioned polycyclic aromatic group may be the above-mentioned polycyclic aromatic group substituted with at least one group selected from the group consisting of, for example, a C₁₋₁₀ alkyl group, a fluorinated derivative thereof and halogen such as F and Cl.

Other than the above, homopolymer whose repeating unit is represented by the general formula (3) or (4) below or polyimide whose repeating unit is represented by the general formula (5) below disclosed in JP H08(1996)-511812 A may be used, for example. The polyimide represented by the formula (5) below is a preferable mode of the homopolymer represented by the formula (3) below.

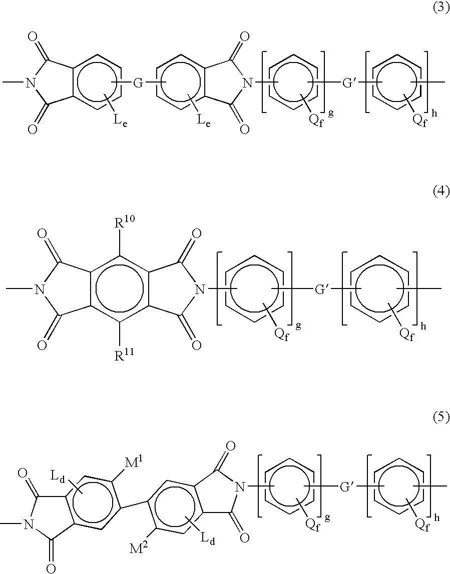

In the above general formulae (3) to (5), G and G′ each are a group selected independently from the group consisting of, for example, a covalent bond, a CH₂ group, a C(CH₃)₂ group, a C(CF₃)₂ group, a C(CX₃)₂ group (wherein X is halogen), a CO group, an O atom, an S atom, an SO₂ group, an Si(CH₂CH₃)₂ group and an N(CH₃) group, and G and G′ may be the same or different.

In the above formulae (3) and (5), L is a substituent, and d and e indicate the number of substitutions therein. L is, for example, halogen, a C₁₋₃ alkyl group, a halogenated C₁₋₃ alkyl group, a phenyl group or a substituted phenyl group, and when there are plural Ls, they may be the same or different. The above-mentioned substituted phenyl group may be, for example, a substituted phenyl group having at least one substituent selected from the group consisting of halogen, a C₁₋₃ alkyl group and a halogenated C₁₋₃ alkyl group. Also, the above-mentioned halogen may be, for example, fluorine, chlorine, bromine or iodine. d is an integer from 0 to 2, and e is an integer from 0 to 3.

In the above formulae (3) to (5), Q is a substituent, and f indicates the number of substitutions therein. Q may be, for example, an atom or a group selected from the group consisting of hydrogen, halogen, an alkyl group, a substituted alkyl group, a nitro group, a cyano group, a thioalkyl group, an alkoxy group, an aryl group, a substituted aryl group, an alkyl ester group and a substituted alkyl ester group and, when there are plural Qs, they may be the same or different. The above-mentioned halogen may be, for example, fluorine, chlorine, bromine or iodine. The above-mentioned substituted alkyl group may be, for example, a halogenated alkyl group. Also, the above-mentioned substituted aryl group may be, for example, a halogenated aryl group. f is an integer from 0 to 4, and g and h respectively are an integer from 0 to 3 and an integer from 1 to 3. Furthermore, it is preferable that g and h are larger than 1.

In the above formula (4), R¹⁰ and R¹¹ are each groups selected independently from the group consisting of hydrogen, halogen, a phenyl group, a substituted phenyl group, an alkyl group and a substituted alkyl group. It is particularly preferable that R¹⁰ and R¹¹ independently are a halogenated alkyl group.

In the above formula (5), M¹ and M² may be the same or different and, for example, halogen, a C₁₋₃ alkyl group, a halogenated C₁₋₃ alkyl group, a phenyl group or a substituted phenyl group. The above-mentioned halogen may be, for example, fluorine, chlorine, bromine or iodine. The above-mentioned substituted phenyl group may be, for example, a substituted phenyl group having at least one substituent selected from the group consisting of halogen, a C₁₋₃ alkyl group and a halogenated C₁₋₃ alkyl group.

Among these polyimides, for example, a polyimide as expressed in the formula (6) below is particularly preferred, and the polyimide is obtainable by reacting 2,2-bis(3,4-dicarboxyphenyl)-hexafluoropropane dianhydride and 2,2,-bis(trifluoromethyl)-4,4-diaminobiphenyl so as to form polyamic acid which is further imidized.

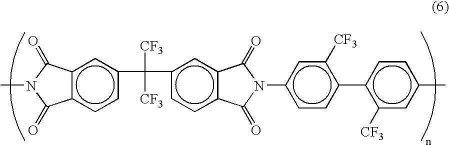

Though there is no specific limitation, the imidization ratio of the polyimides is preferred to be higher, ideally 100%, and the above formulae (1)-(6) represent the state with an imidization ratio of 100%.

Examples of the polyimide other than the above-mentioned ones are described also in U.S. Pat. No. 5,071,997, U.S. Pat. No. 5,480,964 and JP10(1998)-508048 A. Moreover, the above-mentioned polyimide may be, for example, a copolymer obtained by copolymerizing acid dianhydride and diamine other than the above-noted skeleton (repeating unit) suitably.

The above-mentioned acid dianhydride may be, for example, aromatic tetracarboxylic dianhydride. The aromatic tetracarboxylic dianhydride may be, for example, pyromellitic dianhydride, benzophenone tetracarboxylic dianhydride, naphthalene tetracarboxylic dianhydride, heterocyclic aromatic tetracarboxylic dianhydride or 2,2′-substituted biphenyl tetracarboxylic dianhydride.

The pyromellitic dianhydride may be, for example, pyromellitic dianhydride, 3,6-diphenyl pyromellitic dianhydride, 3,6-bis(trifluoromethyl)pyromellitic dianhydride, 3,6-dibromopyromellitic dianhydride or 3,6-dichloropyromellitic dianhydride. The benzophenone tetracarboxylic dianhydride may be, for example, 3,3′,4,4′-benzophenone tetracarboxylic dianhydride, 2,3,3′, 4′-benzophenone tetracarboxylic dianhydride or 2,2′,3,3′-benzophenone tetracarboxylic dianhydride. The naphthalene tetracarboxylic dianhydride may be, for example, 2,3,6,7-naphthalene-tetracarboxylic dianhydride, 1,2,5,6-naphthalene-tetracarboxylic dianhydride or 2,6-dichloro-naphthalene-1,4,5,8-tetracarboxylic dianhydride. The heterocyclic aromatic tetracarboxylic dianhydride may be, for example, thiophene-2,3,4,5-tetracarboxylic dianhydride, pyrazine-2,3,5,6-tetracarboxylic dianhydride or pyridine-2,3,5,6-tetracarboxylic dianhydride. The 2,2′-substituted biphenyl tetracarboxylic dianhydride may be, for example, 2,2′-dibromo-4,4′, 5,5′-biphenyl tetracarboxylic dianhydride, 2,2′-dichloro-4,4′,5,5′-biphenyl tetracarboxylic dianhydride or 2,2′-bis(trifluoromethyl)-4,4′,5,5′-biphenyl tetracarboxylic dianhydride.

Other examples of the aromatic tetracarboxylic dianhydride may include 3,3′,4,4′-biphenyl tetracarboxylic dianhydride, bis(2,3-dicarboxyphenyl)methane dianhydride, bis(2,5,6-trifluoro-3,4-dicarboxyphenyl)methane dianhydride, 2,2-bis(3,4-dicarboxyphenyl)-1,1,1,3,3,3-hexafluoropropane dianhydride, 4,4′-bis(3,4-dicarboxyphenyl)-2,2-diphenylpropane dianhydride, bis(3,4-dicarboxyphenyl)ether dianhydride, 4,4′-oxydiphthalic dianhydride, bis(3,4-dicarboxyphenyl)sulfonic dianhydride, (3,3′,4,4′-diphenylsulfone tetracarboxylic dianhydride), 4,4′-[4,4′-isopropylidene-di(p-phenyleneoxy)]bis(phthalic dianhydride), N,N-(3,4-dicarboxyphenyl)-N-methylamine dianhydride and bis(3,4-dicarboxyphenyl)diethylsilane dianhydride.

Among the above, the aromatic tetracarboxylic dianhydride preferably is 2,2′-substituted biphenyl tetracarboxylic dianhydride, more preferably is 2,2′-bis(trihalomethyl)-4,4′,5,5′-biphenyl tetracarboxylic dianhydride, and further preferably is 2,2′-bis(trifluoromethyl)-4,4′, 5,5′-biphenyl tetracarboxylic dianhydride.

The above-mentioned diamine may be, for example, aromatic diamine. Specific examples thereof include benzenediamine, diaminobenzophenone, naphthalenediamine, heterocyclic aromatic diamine and other aromatic diamines.

The benzenediamine may be, for example, diamine selected from the group consisting of benzenediamines such as o-, m- and p-phenylenediamine, 2,4-diaminotoluene, 1,4-diamino-2-methoxybenzene, 1,4-diamino-2-phenylbenzene and 1,3-diamino-4-chlorobenzene. Examples of the diaminobenzophenone may include 2,2′-diaminobenzophenone and 3,3′-diaminobenzophenone. The naphthalenediamine may be, for example, 1,8-diaminonaphthalene or 1,5-diaminonaphthalene. Examples of the heterocyclic aromatic diamine may include 2,6-diaminopyridine, 2,4-diaminopyridine and 2,4-diamino-S-triazine.

Further, other than the above, the aromatic diamine may be 4,4′-diaminobiphenyl, 4,4′-diaminodiphenyl methane, 4,4′-(9-fluorenylidene)-dianiline, 2,2′-bis(trifluoromethyl)-4,4′-diaminobiphenyl, 3,3′-dichloro-4,4′-diaminodiphenyl methane, 2,2′-dichloro-4,4′-diaminobiphenyl, 2,2′, 5,5′-tetrachlorobenzidine, 2,2-bis(4-aminophenoxyphenyl)propane, 2,2-bis(4-aminophenyl)propane, 2,2-bis(4-aminophenyl)-1,1,1,3,3,3-hexafluoropropane, 4,4′-diamino diphenyl ether, 3,4′-diamino diphenyl ether, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis[4-(4-aminophenoxy)phenyl]propane, 2,2-bis[4-(4-aminophenoxy)phenyl]-1,1,1,3,3,3,-hexafluoropropane, 4,4′-diamino diphenyl thioether or 4,4′-diaminodiphenylsulfone.

The polyetherketone may be, for example, polyaryletherketone represented by the general formula (7) below, which is disclosed in JP 2001-49110 A.

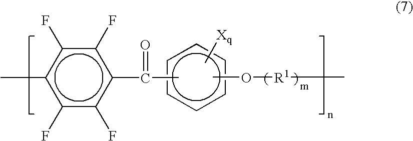

In the above formula (7), X is a substituent, and q is the number of substitutions therein. X is, for example, a halogen atom, a lower alkyl group, a halogenated alkyl group, a lower alkoxy group or a halogenated alkoxy group, and when there are plural Xs, they may be the same or different.

The halogen atom may be, for example, a fluorine atom, a bromine atom, a chlorine atom or an iodine atom, and among these, a fluorine atom is preferable. The lower alkyl group preferably is a C₁₋₆ lower straight or branched alkyl group and more preferably is a C₁₋₄ straight or branched chain alkyl group, for example. More specifically, it preferably is a methyl group, an ethyl group, a propyl group, an isopropyl group, a butyl group, an isobutyl group, a sec-butyl group or a tert-butyl group, and particularly preferably is a methyl group or an ethyl group. The halogenated alkyl group may be, for example, a halide of the above-mentioned lower alkyl group such as a trifluoromethyl group. The lower alkoxy group preferably is a C₁₋₆ straight or branched chain alkoxy group and more preferably is a C₁₋₄ straight or branched chain alkoxy group, for example. More specifically, it further preferably is a methoxy group, an ethoxy group, a propoxy group, an isopropoxy group, a butoxy group, an isobutoxy group, a sec-butoxy group or a tert-butoxy group, and particularly preferably is a methoxy group or an ethoxy group. The halogenated alkoxy group may be, for example, a halide of the above-mentioned lower alkoxy group such as a trifluoromethoxy group.

In the above formula (7), q is an integer from 0 to 4. In the formula (7), it is preferable that q=0 and a carbonyl group and an oxygen atom of an ether that are bonded to both ends of a benzene ring are present at para positions.

Also, in the above formula (7), R¹ is a group represented by the formula (8) below, and m is an integer of 0 or 1.

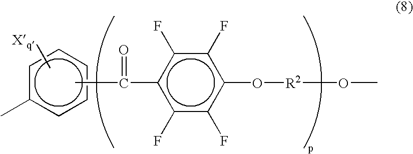

In the above formula (8), X′ is a substituent and is the same as X in the formula (7), for example. In the formula (8), when there are plural X's, they may be the same or different. q′ indicates the number of substitutions in the X′ and is an integer from 0 to 4, preferably, q′=0. In addition, p is an integer of 0 or 1.

In the formula (8), R² is a divalent aromatic group. This divalent aromatic group is, for example, an o-, m- or p-phenylene group or a divalent group derived from naphthalene, biphenyl, anthracene, o-, m- or p-terphenyl, phenanthrene, dibenzofuran, biphenyl ether or biphenyl sulfone. In these divalent aromatic groups, hydrogen that is bonded directly to the aromatic may be substituted with a halogen atom, a lower alkyl group or a lower alkoxy group. Among them, the R² preferably is an aromatic group selected from the group consisting of the formulae (9) to (15) below.

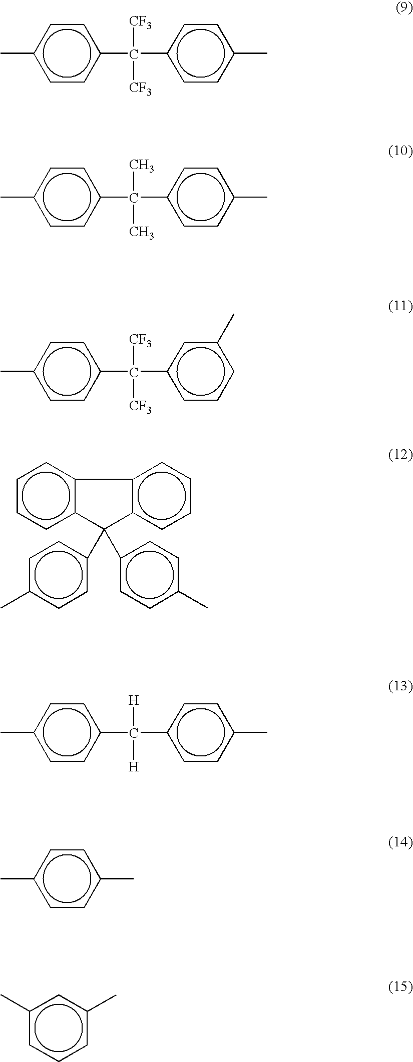

In the above formula (7), the R¹ preferably is a group represented by the formula (16) below, wherein R² and p are equivalent to those in the above-noted formula (8).

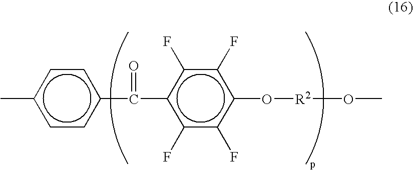

Furthermore, in the formula (7), n indicates a degree of polymerization ranging, for example, from 2 to 5000 and preferably from 5 to 500. The polymerization may be composed of repeating units with the same structure or with different structures. In the latter case, the polymerization form of the repeating units may be block polymerization or random polymerization.

Moreover, it is preferable that an end on a p-tetrafluorobenzoylene group side of the polyaryletherketone represented by the formula (7) is fluorine and an end on an oxyalkylene group side thereof is a hydrogen atom. Such a polyaryletherketone can be represented by the general formula (17) below. In the formula below, n indicates a degree of polymerization as in the formula (7).

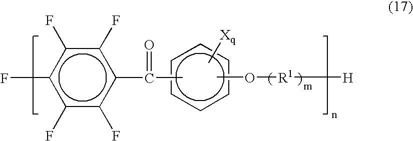

Specific examples of the polyaryletherketone represented by the formula (7) may include those represented by the formulae (18) to (21) below, wherein n indicates a degree of polymerization as in the formula (7).

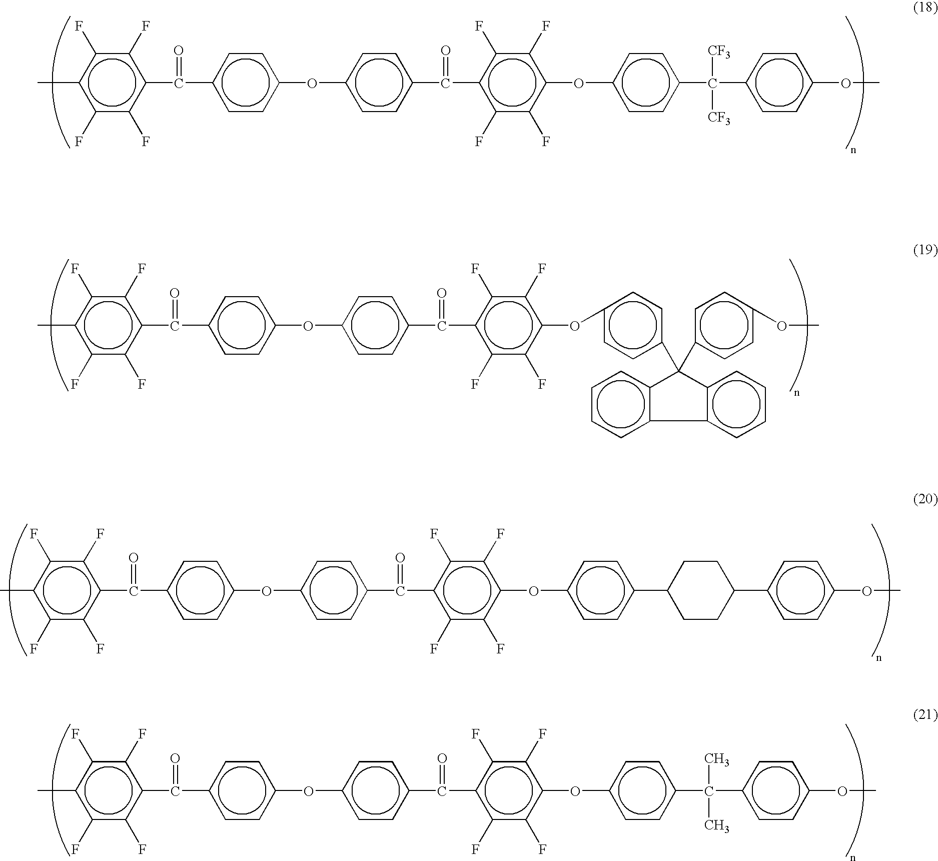

Other than the above, for the polyetherketone, a fluorine-containing polyaryletherketone as described in JP 2001-64226 A or the like can be used preferably, for example.

Other than the above, the polyamide or polyester may be, for example, polyamide or polyester described by JP H10(1998)-508048 A, and their repeating units can be represented by the general formula (22) below.

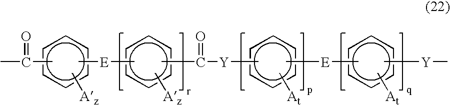

In the above formula (22), Y is O or NH. E is, for example, at least one group selected from the group consisting of a covalent bond, a C₂ alkylene group, a halogenated C₂ alkylene group, a CH₂ group, a C(CX₃)₂ group (wherein X is halogen or hydrogen), a CO group, an O atom, an S atom, an SO₂ group, an Si(R)₂ group and an N(R) group, and Es may be the same or different. In the above-mentioned E, R is at least one of a C₁₋₃ alkyl group and a halogenated C₁₋₃ alkyl group and present at a meta position or a para position with respect to a carbonyl functional group or a Y group.

Further, in the above formula (22), A and A′ are substituents, and t and z respectively indicate the numbers of substitutions therein. Additionally, p is an integer from 0 to 3, q is an integer from 1 to 3, and r is an integer from 0 to 3.

The above-mentioned A is selected from the group consisting of, for example, hydrogen, halogen, a C₁₋₃ alkyl group, a halogenated C₁₋₃ alkyl group, an alkoxy group represented by OR (wherein R is the group defined above), an aryl group, a substituted aryl group by halogenation, a C₁₋₉ alkoxycarbonyl group, a C₁₋₉ alkylcarbonyloxy group, a C₁₋₁₂ aryloxycarbonyl group, a C₁₋₁₂ arylcarbonyloxy group and a substituted derivative thereof, a C₁₋₁₂ arylcarbamoyl group, and a C₁₋₁₂ arylcarbonylamino group and a substituted derivative thereof. When there are plural As, they may be the same or different. The above-mentioned A′ is selected from the group consisting of, for example, halogen, a C₁₋₃ alkyl group, a halogenated C₁₋₃ alkyl group, a phenyl group and a substituted phenyl group and when there are plural A's, they may be the same or different. A substituent on a phenyl ring of the substituted phenyl group can be, for example, halogen, a C₁₋₃ alkyl group, a halogenated C₁₋₃ alkyl group or a combination thereof. The t is an integer from 0 to 4, and the z is an integer from 0 to 3.

Among the repeating units of the polyamide or polyester represented by the formula (22) above, the repeating unit represented by the general formula (23) below is preferable.

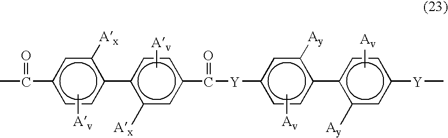

In the formula (23), A, A′ and Y are as defined in the formula (22), and v is an integer from 0 to 3, preferably is an integer from 0 to 2. Although each of x and y is 0 or 1, not both of them are 0.

It is preferable that the optically anisotropic layer contains a liquid crystalline compound from an aspect of decreasing the film thickness or the like. Moreover, the optically anisotropic layer is preferred to contain polyimide so as to decrease the film thickness and also develop the biaxial optical anisotropy, for example.

The optical characteristics of the optically anisotropic layer are not limited particularly, but can be set to either uniaxiality or biaxiality suitably in order to obtain an optimum effect corresponding to the intended use of the retardation film. For example, for realizing a favorable viewing angle compensation in a liquid crystal cell of a vertically-aligned (VA) type liquid crystal display, a negative uniaxial refractive index anisotropy is provided preferably. In an alternative example, the optically anisotropic layer is preferred to have a biaxial refractive index anisotropy in order to compensate the axial displacement of the polarizer from an oblique direction.

Furthermore, it is preferable that the optically anisotropic layer is formed on a transparent base. Though there is no particular limitation on the material of the transparent base, for example, a polymer film or the like can be used. Similarly, though polymers used for the polymer film are not limited particularly, preferred examples include: polyester-based polymers such as polyethylene terephthalate and polyethylene naphthalate; cellulose-based polymers such as diacetyl cellulose and triacetyl cellulose; acrylic polymers such as polymethyl methacrylate; styrene-based polymers such as polystyrene and styrene-acrylonitrile copolymer (AS resin); polycarbonate-based polymers such as a copolymer of bisphenol A and carbonic acid; linear or branched polyolefins such as polyethylene, polypropylene, and ethylene-propylene copolymer; polyolefins including cyclo-structures, such as polynorbornene; vinyl chloride-based polymers; amide-based polymers such as nylon and aromatic polyamide; imide-based polymers; sulfone-based polymers; polyethersulfone-based polymers; polyether ether ketone-based polymers; polyphenylene sulfide-based polymers; vinyl alcohol-based polymers; vinylidene chloride-based polymers; vinyl butyral-based polymers; arylate-based polymers; polyoxymethylene-based polymers; and epoxy-based polymers. These polymers can be used alone or as a mixture with at least any one of the other polymers. A polymer film or the like described in the above-mentioned JP 2001-343529 A (WO 01/37007) can be used preferably as well.

Though there is no particular limitation, the retardation film of the present invention is produced preferably by the producing method of the present invention as described below.

(Method of Producing Retardation Film)

The following description is about a method for producing the retardation film of the present invention.

The method for producing the retardation film of the present invention includes: a step of applying a solution containing a liquid crystalline compound and a polymer that reacts with polarized ultraviolet light, onto an optically anisotropic layer; a step of drying the solution so as to form a precursor layer of an optical retardation layer; and a step of irradiating the precursor layer surface with polarized ultraviolet light.

In a conventional producing method to use an alignment film, a solution containing a polymer that reacts with polarized ultraviolet light is used as a solution for forming an alignment film, while a solution containing a liquid crystalline compound is used separately for a solution for forming an optical retardation layer. According to this method, the solution for forming an alignment film is applied onto an optically anisotropic layer and dried, subsequently polarized ultraviolet light is irradiated to form an alignment film, and further the solution for an optical retardation layer is applied thereon to be dried to form an optical retardation layer. However, as having been mentioned above, sometimes the solution for forming an alignment film will penetrate into the optically anisotropic layer and loses its functions as an alignment film.

In the present invention, it has been found that when a solution containing both a liquid crystalline compound and a polymer that reacts with polarized ultraviolet light is applied onto an optically anisotropic layer, the liquid crystal alignment performance will be improved in comparison with a case of applying a solution containing only the polymer but not the liquid crystalline compound. Therefore in the present invention, by drying the solution so as to form a precursor layer of the optical retardation layer and by irradiating the surface of the precursor layer with polarized ultraviolet light, an optical retardation layer with a precisely-controlled alignment direction can be formed.

Since an optical retardation layer can be formed on an optically anisotropic layer without using any of an alignment film, an alignment substrate, an adhesive or the like, the cost can be reduced for the materials. Furthermore, since steps of forming an alignment film and transferring the optical retardation layer can be omitted, the number of steps for production can be decreased to improve the production efficiency and further decrease the cost.

It is preferable that the method for producing the retardation film of the present invention further includes a step of crosslinking the liquid crystalline compound. The method of crosslinking is not limited particularly, and it can be an optical crosslinking and a thermal crosslinking. Crosslinking with unpolarized ultraviolet light is preferred, since the reactivity is high and the control is performed easily. By irradiating the surface of the precursor layer with the unpolarized ultraviolet light, the liquid crystalline compound can be crosslinked.

After forming a first retardation layer, a second retardation layer is formed thereon by the same method. In this manner, the second retardation layer can be laminated directly on the first retardation layer. Further, any numbers of layers can be laminated arbitrarily by repeating the same step.

More specifically, the method for producing the retardation film of the present invention includes the following steps. It should be noted that this is just one embodiment of the producing method of the present invention, and the present invention will not be limited to the method.

Specifically, an optically anisotropic layer is prepared first. For obtaining an optically anisotropic layer shaped like a stretched film, the following steps can be applied, for example. First, a polymer compound such as a thermoplastic polymer or the like is shaped to a polymer film by extrusion or flow expansion, for example. The polymer film is treated further by a roll-vertical stretching or the like so as to obtain a film-like optically anisotropic layer having a uniaxial refractive index anisotropy. Alternatively, when the polymer film is treated by a tenter transverse stretching, a biaxial stretching or the like, a film-like anisotropic layer having a biaxial refractive index anisotropy is obtained.

For obtaining the optically anisotropic layer as a coating film, the following steps can be applied, for example. First, a base is prepared. A plastic base or the like is preferred for this base, and a transparent base such as an optically isotropic polymer film is preferred. Though the polymer used for this polymer film is not limited particularly, preferable examples are as described above. In the meantime, a polymer compound such as the polyimide is dissolved in a solvent so as to prepare a solution. The solvent is not limited particularly as long as it can dissolve the polymer compound. The examples include esters such as ethyl acetate, propyl acetate, butyl acetate, isobutyl acetate, butyl propionate, and caprolactone; ketones such as acetone, methyl ethyl ketone, methyl propyl ketone, methyl isopropyl ketone, methyl isobutyl ketone, diethyl ketone, cyclopentanone, cyclohexanone and methyl cyclohexanone; and hydrocarbons such as toluene. Any of these solvents can be used alone or used with at least one of other solvents.

Then, the solution is applied onto the base and dried by heat or the like, so that a retardation (Rth) in the thickness direction is developed and thus, a coating film that meets nx=ny>nz, i.e., an optically anisotropic layer having a negative uniaxial refractive index anisotropy, is obtained. Furthermore, this optically anisotropic layer is stretched or shrunk together with the base so as to be provided with an in-plane molecular alignment, thereby a coating film having a characteristic of nx>ny>nz (or ny>nx>nz), i.e., an optically anisotropic layer having a biaxial refractive index anisotropy, can be obtained. Here, the coating method is not limited particularly, but any methods selected from spin coating, roller coating, flow coating, printing, dip coating, flow-expanding, bar coating and gravure printing can be used.

In the present invention, nx, ny and nz denote refractive indices in the X-, Y- and Z-axes directions in the various films, the optically anisotropic layer, the optical retardation layer and the like. Either the X-axis or the Y-axis denotes an axial direction exhibiting the maximum refractive index within the film or the layer, and the other is an axial direction perpendicular to the axis. And the Z-axis denotes a thickness direction perpendicular to the X- and Y-axes directions.

Next, an optical retardation layer is formed on the optically anisotropic layer. First, a solution containing a liquid crystalline compound and a polymer that reacts with polarized ultraviolet light is prepared. Though the mixing ratio of the liquid crystal compound to the polymer is not limited particularly and it varies depending on the kinds of the materials, for example, it is from 9:1 to 1:1 by weight, and preferably from 5:1 to 3:1.

Though applicable liquid crystalline compounds are not limited particularly as long as they can be coated, for example, the above-mentioned liquid crystalline compounds and the polymers can be used for this purpose.

Though the polymer is not limited particularly as long as it contains, in the molecular chain, a functional group that reacts with polarized ultraviolet light, but any polymers suitable for the purpose can be used. Examples of the functional groups include, for example, groups that exhibit a dimerization reaction with respect to the polarized ultraviolet light, such as a cinnamoyl group, a coumarin group, a chalcone group; and an azo group that exhibits an optical anisotropic reaction.

And this solution is applied onto the optically anisotropic layer and dried to form a precursor layer of the optical retardation layer. Furthermore, it was irradiated with polarized ultraviolet light so as to react the polymer and align the liquid crystalline compound at the same time.

Here, the alignment direction of the liquid crystalline compound can be controlled arbitrarily by changing the incidence angle of the polarized ultraviolet light to be irradiated. For example, in a viewing angle compensation for a bend-aligned OCB type liquid crystalline cell, it is required for the alignment state that the liquid crystal is arrayed to cross the positive anisotropic axis of the optically anisotropic layer at right angles, and further that the liquid crystal is inclined in the thickness direction of the optical retardation layer. In such a case, the polarized face of the polarized ultraviolet light is made to cross at right angles or parallel with respect to the positive anisotropic optical axis of the optically anisotropic layer, and furthermore, the incidence angle is inclined with respect to the plane of the optical retardation layer. In such a case, the optically anisotropic layer can be, for example, an optically anisotropic layer that exhibits a positive uniaxial A-plate retardation characteristic and a biaxial optically anisotropic layer that has the characteristics of both the A-plate component and a negative C-plate component.

Furthermore, as required, the liquid crystalline compound is crosslinked through treatments such as heating, light irradiation or the like so as to form an optical retardation layer.

When the optical retardation layer contains a polymer of a liquid crystalline compound, the polymer can be used at the time of preparing the solution. Alternatively, a solution of a monomer is prepared first, and the monomer can be polymerized at the time of crosslinking through treatments such as heating and irradiation.

The retardation of the present invention can be produced as mentioned above, but the present invention is not limited to the example. For example, in the case of obtaining an optically anisotropic layer containing a liquid crystalline compound, it is possible to form the optically anisotropic layer by the same method as in the case of forming the optical retardation layer.

(Optical Element and Image Display Apparatus)

Next, an optical element using the retardation film of the present invention and an image display apparatus will be described below.

The optical element of the present invention includes the retardation film of the present invention and a polarizer. Though there is no particular limitation on the remaining constituent elements, it is preferable, for protecting the polarizer and for suppressing deformation of the optical element, that a transparent protective film is included further and the transparent protective film is sandwiched between the retardation film and the polarizer. For example, a polarizing plate including a polarizer and a transparent protective film laminated thereon is prepared and the retardation film of the present invention is laminated further to provide the optical element of the present invention. Furthermore, the optical element of the present invention can include suitably arbitrary constituent elements other than the polarizer and the transparent protective film. Hereinafter, the respective constituent elements of the optical element of the present invention will be described specifically below.

The polarizer is not particularly limited but a stretched polymer film is preferred since favorable optical characteristics can be obtained easily. It can be prepared by a conventionally known method of, for example, dyeing by allowing a film of various kinds to adsorb a dichroic material such as iodine or a dichroic dye, followed by cross-linking, stretching and drying. Especially, films that transmit linearly polarized light when natural light is made to enter those films are preferable, and films having excellent light-transmittance and polarization degree are preferable. Examples of the film of various kinds in which the dichroic material is to be adsorbed include hydrophilic polymer films such as polyvinyl alcohol (PVA)-based films, partially-formalized PVA-based films, partially-saponified films based on ethylene-vinyl acetate copolymer and cellulose-based films. Other than the above, polyene aligned films such as dehydrated PVA and dehydrochlorinated polyvinyl chloride can be used, for example. Among them, the polyvinyl alcohol-based film is preferable since favorable optical characteristics can be obtained easily. In addition, the thickness of the polarizing film generally ranges from 1 to 80 μm, though it is not limited to this.

The transparent protective layer is not particularly limited, but a conventionally known transparent film can be used. For example, transparent protective films having excellent transparency, mechanical strength, thermal stability, moisture shielding property and isotropism are preferable. Specific examples of materials for such a transparent protective layer can include cellulose-based resins such as triacetylcellulose (TAC), and transparent resins based on polyester, polycarbonate, polyamide, polyimide, polyethersulfone, polysulfone, polystyrene, polynorbornene, polyolefin, acrylic, acetate and the like. Thermosetting resins or ultraviolet-curing resins based on the acrylic, urethane, acrylic urethane, epoxy, silicones and the like can be used as well. Among them, a TAC film having a surface saponified with alkali or the like is preferable in view of the polarization property and durability. The polymer film described in JP 2001-343529A (WO 01/37007) also can be used for the transparent protective layer.

It is preferable that the transparent protective film is colorless. More specifically, a retardation value (Rth) of the film in its thickness direction preferably ranges from −90 nm to +75 nm, more preferably ranges from −80 nm to +60 nm, and particularly preferably ranges from −70 nm to +45 nm. When the retardation value is within the range of −90 nm to +75 nm, coloration (optical coloration), which is caused by the protective film, can be solved sufficiently. In the Formula (V) below, nx, ny and nz are similar to those described above, and d indicates the thickness of the transparent protective film.
Rth=[{(nx+ny)/2}−nz]×d (V)

The thickness of the transparent protective film is not particularly limited but can be determined suitably according to retardation or protection strength, for example. In general, the thickness is in the range not greater than 500 μm, preferably from 5 to 300 μm, and more preferably from 5 to 150 μm.

The transparent protective film can be formed suitably by a conventionally known method such as a method of applying the above-mentioned various transparent resins onto a polarizer or a method of laminating the transparent resin film on the polarizer, or can be a commercially available product. In a case where the retardation film of the present invention includes a transparent base, the transparent base can serve also as the transparent protective film.

The transparent protective film further may be subjected to, for example, a hard-coating treatment, an antireflection treatment, treatments for anti-sticking, diffusion and anti-glare and the like. The hard-coating treatment aims at preventing scratches on the surfaces, and is a treatment of, for example, providing a hardened coating film that is formed of a curable resin and has excellent hardness and smoothness onto a surface of the transparent protective film. The curable resin can be, for example, ultraviolet-curing resins of silicone base, urethane base, acrylic, and epoxy base. The treatment can be carried out by a conventionally known method. The anti-sticking treatment aims at preventing adjacent layers from sticking to each other. The antireflection treatment aims at preventing reflection of external light on the surface of the polarizing plate, and can be carried out by forming a conventionally known antireflection layer or the like.

When external light is reflected on the surface of the polarizing plate, the reflection will inhibit visibility of light transmitted through the polarizing plate. The anti-glare treatment aims at preventing such inhibition of visibility. The anti-glare treatment can be carried out, for example, by providing microscopic asperities on a surface of the transparent protective film by a conventionally known method. Such microscopic asperities can be provided, for example, by roughening the surface by sand-blasting or embossing, or by blending transparent fine particles in the above-described transparent resin when forming the transparent protective film.

The above-described transparent fine particles may be silica, alumina, titania, zirconia, stannic oxide, indium oxide, cadmium oxide, antimony oxide or the like. Other than the above, inorganic fine particles having an electrical conductivity or organic fine particles comprising, for example, crosslinked or uncrosslinked polymer particles can be used as well. The average particle diameter of the transparent fine particles ranges, for example, from 0.5 to 20 μm, though there is no particular limitation. In general, a blend ratio of the transparent fine particles preferably ranges from 2 to 70 parts by weight, and more preferably ranges from 5 to 50 parts by weight with respect to 100 parts by weight of the above-described transparent resin, though there is no particular limitation.

The anti-glare layer in which the transparent fine particles are blended can be used as the transparent protective film itself or provided as a coating layer coated onto the transparent protective film surface. Furthermore, the anti-glare layer also can function as a diffusion layer to diffuse light transmitted through the polarizing plate and thereby widen the viewing angle (i.e., visually-compensating function).

The antireflection layer, the anti-sticking layer, the diffusion layer and the anti-glare layer mentioned above can be laminated on the polarizing plate, as a sheet of optical layers comprising these layers, separately from the transparent protective film.

The polarizing plate can include further conventionally-known optical layers that have been used for forming liquid crystal displays or the like, such as a polarizing plate, a reflector, a semitransparent reflector, and a brightness-enhancement film as mentioned below. These optical layers can be of one kind or at least two kinds of optical layers can be used together. The optical layer can be composed of a single layer or a laminate of at least two layers. Such an integrated polarizing plate will be described below.

First, an example of a reflective polarizing plate or a semitransparent reflective polarizing plate will be described. The reflective polarizing plate is prepared by laminating further a reflector on the polarizer and the transparent protective film of the present invention, and the semitransparent reflective polarizing plate is prepared by laminating a semitransparent reflector on the polarizer and the transparent protective film.

For example, such a reflective polarizing plate is arranged on a backside of a liquid crystal cell in order to make a liquid crystal display (reflective liquid crystal display) to reflect incident light from a visible side (display side). The reflective polarizing plate has some merits, for example, assembling of light sources such as a backlight can be omitted, and the liquid crystal display can be thinned further.

The reflective polarizing plate can be formed in any known manner such as forming a reflector of metal or the like on one surface of a polarizing plate having a certain elastic modulus. More specifically, one example thereof is a reflective polarizing plate formed by matting one surface (surface to be exposed) of a transparent protective film of the polarizing plate as required, and providing the surface with a deposited film or a metal foil comprising a reflective metal such as aluminum.

An additional example of a reflective polarizing plate is prepared by forming, on a transparent protective film having a surface with microscopic asperities due to microparticles contained in various transparent resins, a reflector corresponding to the microscopic asperities. The reflector having a microscopic asperity surface diffuses incident light irregularly so that directivity and glare can be prevented and irregularity in color tones can be controlled. The reflector can be formed by attaching the metal foil or the metal deposited film directly on an asperity surface of the transparent protective film in any conventional and appropriate methods including deposition and plating such as vacuum deposition, ion plating and sputtering.

As mentioned above, the reflector can be formed directly on a transparent protective film of a polarizing plate. Alternatively, the reflector can be used as a reflecting sheet formed by providing a reflecting layer onto an appropriate film similar to the transparent protective film. Since a typical reflecting layer of a reflector is made of a metal, it is preferably used in a state such that the reflecting surface of the reflecting layer is covered with the film, a polarizing plate or the like in order to prevent a reduction of the reflection rate due to oxidation, and furthermore, the initial reflection rate is maintained for a long period, and a separate formation of a transparent protective film is avoided.

A semitransparent polarizing plate is provided by replacing the reflector in the above-mentioned reflective polarizing plate by a semitransparent reflector, and it is exemplified by a half-mirror that reflects and transmits light at the reflecting layer.

For example, such a semitransparent polarizing plate is arranged on a backside of a liquid crystal cell. In a liquid crystal display including the semitransparent polarizing plate, incident light from the visible side (display side) is reflected to display an image when a liquid crystal display is used in a relatively bright atmosphere, while in a relatively dark atmosphere, an image is displayed by using a built-in light source such as a backlight on the backside of the semitransparent polarizing plate. In other words, the semitransparent polarizing plate can be used to form a liquid crystal display that can save energy for a light source such as a backlight under a bright atmosphere, while a built-in light source can be used under a relatively dark atmosphere.

The following description is about an example of a polarizing plate prepared by further laminating a brightness-enhancement film on the polarizer and the transparent protective film.

A suitable example of the brightness-enhancement film is not particularly limited, but it can be selected from a multilayer thin film of a dielectric or a multilayer lamination of thin films with varied refraction aeolotropy that transmits linearly polarized light having a predetermined polarization axis while reflecting other light. Examples of such a brightness-enhancement film include trade name: “D-BEF” manufactured by 3M Co. Also a cholesteric liquid crystal layer, more specifically, an aligned film of a cholesteric liquid crystal polymer or an aligned liquid crystal layer fixed onto a supportive film base can be used as the brightness-enhancement film. Such a brightness-enhancement film reflects either clockwise or counterclockwise circularly polarized light while transmitting other light. Examples of such a brightness-enhancement film include trade name: “PCF 350” manufactured by Nitto Denko Corporation; trade name: “Transmax” manufactured by Merck and Co., Inc.

The optical element of the present invention can be produced by any conventionally known method without any particular limitations. For example, it can be produced by a suitable lamination of individual constituent elements such as the polyimide film, the polarizer, the protective layer, etc. The kind of adhesive agent or adhesive is not particularly limited but can be determined suitably depending on materials of the above-noted constituent elements. For example, it is possible to use a polymer adhesive based on acrylic substances, vinyl alcohol, silicone, polyester, polyurethane or polyether, or a rubber-based adhesive. It should be noted that, although there is no clear distinction between the “adhesive” and the “adhesive agent” in the present invention, an adhesive that allows bonded objects to peel off from each other or re-bond to each other relatively easily among the other adhesives is referred to as the “adhesive agent,” for the sake of convenience. The adhesive agent and the adhesive mentioned above do not peel off easily even when being exposed to moisture or heat, for example, and have excellent light transmittance and polarization degree. More specifically, these adhesive agent and adhesive preferably are PVA-based adhesives when the polarizer is a PVA-based film, in light of stability of adhering treatment. These adhesive and adhesive agent may be applied directly to surfaces of the polarizer and the protective layer, or a layer of a tape or a sheet formed of the adhesive or adhesive agent may be arranged on the surfaces thereof. Further, when these adhesive and adhesive agent are prepared as an aqueous solution, for example, other additives or a catalyst such as an acid catalyst may be blended as necessary. In the case of applying the adhesive, other additives or a catalyst such as an acid catalyst further may be blended in the aqueous solution of the adhesive. The thickness of the adhesive layer is not particularly limited but may be, for example, 1 to 500 nm, preferably 10 to 300 nm, and more preferably 20 to 100 nm.

Each of the polarizer, the transparent protective film, the optical layer and the adhesive agent layer that form the optical element of the present invention as described above may be treated suitably with an UV absorber such as salicylate ester compounds, benzophenone compounds, benzotriazole compounds, cyanoacrylate compounds or nickel complex salt-based compounds, thus providing an UV absorbing capability.

Specific examples of the optical elements of the present invention include, for example, an optical element formed by adhering a polarizer onto one surface of the retardation film of the present invention. Though there is no particular limitation on the method for producing the optical element, for example, the optical element can be produced by a method including: a step of preparing a retardation film produced by the producing method of the present invention and a polarizer, and applying an adhesive on at least one of the retardation film and the polarizer; a step of drying the adhesive; and a step of bonding the retardation film and the polarizer via the surface applied with the adhesive. The step of drying the adhesive can be carried out before bonding the retardation film and the polarizer, or it can be carried out after the bonding, depending on the kind or the like of the adhesive. Alternatively, instead of bonding after the application of the adhesive, the optical element can be produced by bonding while dropping an adhesive or the solution and subsequently drying.

In an alternative example of embodiments of the optical elements according to the present invention, a polarizing plate that is prepared by adhering a transparent protective film(s) on either surface or preferably both surfaces of a polarizer is bonded to a retardation film of the present invention via the adhesive layer. Though there is no particular limitation on the method for producing such an optical element, for example, the optical element can be produced by a method including: a step of preparing a retardation film produced by the producing method of the present invention and a polarizer to which a transparent protective film adhered, and applying an adhesive on at least one of the retardation film and the transparent protective film; a step of drying the adhesive; and a step of bonding the retardation film and the transparent protective film via the surface applied with the adhesive. The step of drying the adhesive can be carried out before bonding the retardation film and the transparent protective film or after the bonding, depending on the kind or the like of the adhesive.

The optical element of the present invention can be produced also by a method of laminating on a surface of a liquid crystal cell or the like the respective constituent elements separately in a certain order, in a process for producing a liquid crystal display or the like. However, the method of laminating previously the respective constituent elements so as to form an optical element of the present invention and using the optical element for producing a liquid crystal display or the like is preferred, since stability in quality and assembling workability are excellent, and efficiency in producing a liquid crystal display can be improved.

It is preferable that the optical element of the present invention further has the adhesive agent layer or the adhesive layer described above on one or both of its outer surfaces because easier lamination onto other members such as a liquid crystal cell can be achieved. The adhesive agent layer or the like can be a monolayer or a laminate. The laminate can include monolayers different from each other in the compositions or in the types. When arranged on both surfaces of the optical element, the adhesive agent layers or the like can be the same or can be different from each other in compositions or types. In the case where a surface of the adhesive agent layer or the like provided on the optical element is exposed, it is preferable to cover the above-noted surface with a separator so as to prevent contamination until the adhesive agent layer or the like is put to use. The separator can be made by coating a suitable film with a peeling coat of a peeling agent such as a silicone-based agent, a long-chain alkyl-based agent, a fluorine-based agent, an agent comprising molybdenum sulfide or the like as necessary. The material for the film is not particularly limited but can be similar to that for the transparent protective film, for example.

There is no particular limitation on how to use the optical element of the present invention. However, the optical element is suitable for use in various image display apparatuses, for example, arranged on the surface of a liquid crystal cell.

Next, the image display apparatus of the present invention will be described. The image display apparatus of the present invention includes either a retardation film of the present invention or an optical element of the present invention. Other than that, the image display apparatus of the present invention is not limited particularly. The producing method, the structure, the use can be selected arbitrarily, and conventionally known configurations can be applied suitably.

The kind of the image display apparatus of the present invention is not particularly limited but preferably is a liquid crystal display. For example, it is possible to arrange the optical film or the optical element of the present invention on one surface or both surfaces of the liquid crystal cell so as to form a liquid crystal panel and to use it in a reflection-type, semi-transmission-type or transmission and reflection type liquid crystal display. The kind of the liquid crystal cell forming the liquid crystal display can be selected arbitrarily. For example, it is possible to use any type of liquid crystal cells such as an active-matrix driving type represented by a thin-film transistor type, or a simple-matrix driving type represented by a twisted nematic type or a super twisted nematic type.

A typical liquid crystal cell is composed of opposing liquid crystal cell substrates and a liquid crystal injected into a space between the substrates. The liquid crystal cell substrates can be made of glass, plastics or the like without any specific limitations. Materials for the plastic substrates can be selected from conventionally known materials without any specific limitations.

Further, the optical element of the present invention may be provided on one surface or both surfaces of the liquid crystal cell. When members such as the optical element are provided on both surfaces of the liquid crystal cell, they can be the same or different in kind. Moreover, for producing a liquid crystal display, one or at least two layers of appropriate members such as a prism array sheet, a lens array sheet, an optical diffuser and a backlight can be arranged at proper positions.

The structure of the liquid crystal panel in the liquid crystal display according to the present invention is not particularly limited. However, it is preferable that the liquid crystal cell, the retardation film of the present invention, the polarizer and the transparent protective film are included, for example, and one surface of the liquid crystal cell is laminated with the retardation film, the polarizer and the transparent protective film in this order. In the case where a birefringent layer (an optically anisotropic layer or an optical retardation layer) in the retardation film of the present invention is formed on the transparent base, the arrangement is not limited particularly. In an example, the birefringent layer side can face the liquid crystal cell, and the transparent base side can face the polarizer.

In the case where the liquid crystal display of the present invention further includes a light source, this light source preferably is a flat light source emitting polarized light so as to use light energy effectively, though there is no specific limitation.

Furthermore, the image display apparatus according to the present invention is not limited to the liquid crystal display described above but also can be a self-light-emitting display such as an organic electroluminescence (EL) display, a plasma display (PD) and an FED (field emission display). When used in self-light-emitting flat displays, for example, circularly polarized light can be obtained by setting the in-plane retardation value of the optical anisotropic layer of the retardation film of the present invention to be λ/4, and thus it can be used as an antireflection filter.

The following is a description of an electroluminescence (EL) display according to the present invention. The EL display of the present invention has the retardation film or the optical element of the present invention and may be either an organic EL display or an inorganic EL display.

In recent years, for EL displays, it has been suggested to use an optical film such as a polarizer or a polarizing plate together with a λ/4 plate for preventing reflection from an electrode in a black state. The retardation film and the optical element of the present invention are very useful particularly when any of linearly polarized light, circularly polarized light and elliptically polarized light is emitted from the EL layer, or when obliquely emitted light is polarized partially even if natural light is emitted in the front direction.

The following description is directed to a typical organic EL display. In general, an organic EL display has a luminant (organic EL ruminant) that is prepared by laminating a transparent electrode (an anode), an organic ruminant layer and a metal electrode (a cathode) in a certain order on a transparent substrate. Here, the organic ruminant layer is a laminate of various organic thin films. Known examples thereof include a laminate of a hole injection layer made of triphenylamine derivative or the like and a ruminant layer made of a fluorescent organic solid such as anthracene; a laminate of the ruminant layer and an electron injection layer made of perylene derivative or the like; or a laminate of the hole injection layer, the ruminant layer and the electron injection layer.

The organic EL display emits light on the following principle: a voltage is applied to the anode and the cathode so as to inject holes and electrons into the organic ruminant layer, and re-bonding of these holes and electrons generates energy. Then, this energy excites the fluorescent substance, which emits light when it returns to the basis state. The mechanism of the re-bonding is similar to that of an ordinary diode. This implies that current and the light emitting intensity exhibit a considerable nonlinearity accompanied with a rectification with respect to the applied voltage.

It is necessary for the organic EL display that at least one of the electrodes is transparent so as to obtain luminescence at the organic luminant layer. In general, a transparent electrode of a transparent conductive material such as indium tin oxide (ITO) is used for the anode. Use of substances having small work function for the cathode is important for facilitating the electron injection and thereby raising luminous efficiency, and in general, metal electrodes such as Mg—Ag, and Al—Li may be used.

In an organic EL display configured as described above, it is preferable that the organic ruminant layer is made of a film that is extremely thin such as about 10 nm. Therefore, the organic luminant layer can transmit substantially the whole light like the transparent electrode. As a result, when the layer does not illuminate, a light beam entering from the surface of the transparent substrate and passing through the transparent electrode and the organic luminant layer before being reflected at the metal layer comes out again to the surface of the transparent substrate. Thereby, the display surface of the organic EL display looks like a mirror when viewed from the outside.

The organic EL display according to the present invention preferably includes, for example, the retardation film or the optical element according to the present invention on the surface of the transparent electrode. With this configuration, the organic EL display has an effect of suppressing external reflection and improving visibility or the like. For example, the retardation film and the optical element including the polarizing plate of the present invention function to polarize light which enters from outside and is reflected by the metal electrode, and thus the polarization has an effect that the mirror of the metal electrode cannot be viewed from the outside. Particularly, the mirror of the metal electrode can be blocked completely by forming the retardation film of the present invention with a quarter wavelength plate and adjusting an angle formed by the polarization directions of the polarizing plate and the retardation film to be π/4. That is, the polarizing plate transmits only the linearly polarized light component among the external light entering the organic EL display. In general, the linearly polarized light is changed into elliptically polarized light by the retardation film. However, when the retardation film is a quarter wavelength plate and when the above-noted angle is π/4, the light is changed into circularly polarized light.

For example, this circularly polarized light passes through the transparent substrate, the transparent electrode, and the organic thin film. After being reflected by the metal electrode, the light passes again through the organic thin film, the transparent electrode and the transparent substrate, and turns into linearly polarized light at the retardation film. Moreover, since the linearly polarized light crosses the polarization direction of the polarizing plate at a right angle, it cannot pass through the polarizing plate. As a result, the mirror of the metal electrode can be blocked completely as mentioned earlier.

### EXAMPLES

Next, Examples of the present invention will be described below. In the following Examples, first, either an optically anisotropic layer exhibiting a negative uniaxial C-plate property or a biaxial optically anisotropic layer having both a positive A-plate component and a C-plate component, and further an incline-aligned retardation layer is formed on the surface so as to form a retardation film.

### Example 1

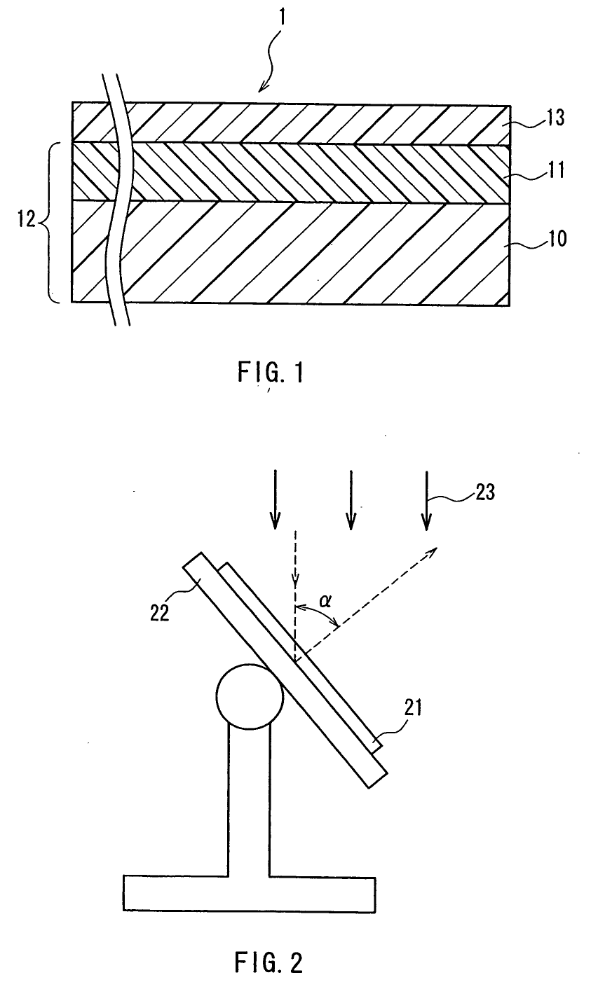

FIG. 1 shows a cross-sectional view of a retardation film produced in this Example. As shown in this figure, the retardation film 1 includes a transparent base 10, an optically anisotropic layer 11 and an optical retardation layer 13 laminated in this order, and the transparent base 10 and the optically anisotropic layer 11 form a base-attached anisotropic layer 12.

The retardation film 1 was produced in the following manner. First, a triacetylcellulose (TAC) base about 80 μm in thickness was prepared to make the transparent base 10.

Next, the base-attached anisotropic layer 12 was produced. Specifically, a 15 wt % solution of polyimide was prepared first. The polyimide in use was a copolymer of 2,2-bis(3,4-dicarboxyphenyl) hexafluoropropane (6FDA) and 2,2′-bis(trifluoromethyl)-4,4′-diaminobiphenyl (PFMB), and methyl isobutyl ketone (MIBK) was used for a solvent. This polyimide solution was applied onto the transparent base 10 and dried with heat at 130° C. for 1 minute, thereby forming the optically anisotropic layer 11 about 6 μm in thickness and exhibiting a negative uniaxial C-plate retardation property, so that the base-attached anisotropic layer 12 was formed.

Separately, a coating solution for making the optical retardation layer 13 was prepared. Specifically, 3.75 g of a cyclopentanone solution (trade name: LPP/F301CP manufactured by Vantico K.K) of a polymer (photopolymerization polymer) that reacts with polarized ultraviolet light, and 5 g of a cyclopentanone solution of an ultraviolet polymeric nematic liquid crystalline compound (trade name: LC/CB483CP manufactured by Vantico K.K.) were mixed, to which 0.01 g of a photoinitiator (trade name: Irgacure907 manufactured by Ciba Specialty Products) was added and the mixture was stirred for 10 minutes so as to provide a coating solution.

Next, on a surface of the optically anisotropic layer 11, the coating solution was spin-coated at a rotational speed of 1500 rpm. This was dried with heat for 20 minutes under an atmosphere of 130° C. so as to form a precursor layer of an optical retardation layer. In this manner, a laminate including the transparent base 10, the optically anisotropic layer 11 and the precursor layer laminated in this manner, was obtained. The laminate was set on a hot-plate at 70° C., with its precursor layer facing upward, and irradiated with polarized ultraviolet light with a luminance of 6 mW/cm² for 3 minutes, thereby aligning the photopolymerization polymer. FIG. 2 shows schematically the side view at the time of the polarized ultraviolet irradiation. As shown in this figure, the laminate 21 was set on the hot-plate 22 and irradiated with the polarized ultraviolet light 23 from right above. At this time, the hot-plate 22 was inclined so that an incidence angle α of the polarized ultraviolet light 23 with respect to the surface of the laminate 21 became 60°. The incidence angle α is an angle formed by a face perpendicular to the laminate 21 and the incidence direction of the polarized ultraviolet light 23, and when the laminate 21 is parallel, α=0°. After irradiating with the polarized ultraviolet light 23, the laminate 21 was kept uncontrolled for 3 minutes at room temperature. Subsequently, unpolarized ultraviolet light was irradiated to optically crosslink the liquid crystalline compound, thereby converting the precursor layer into the optical retardation layer 13 so as to obtain the retardation film 1.

The retardation film 1 produced in this example was observed with a polarization microscope. Specifically, the retardation film 1 was observed in a state where the upper polarizing plate and the lower polarizing plate set in the polarization microscope crossed each other at right angles. The results showed that the light transmission amount was minimized when the polarization direction of the polarized ultraviolet light 23 irradiated in the step of producing the retardation film became parallel with respect to a polarization axis of any of the upper and lower polarizing plates of the polarization microscope. This result shows that the axial direction reflected on the film plane of the optical axis of the retardation film 1 matches the polarization direction of the polarized ultraviolet light 23.

### Example 2

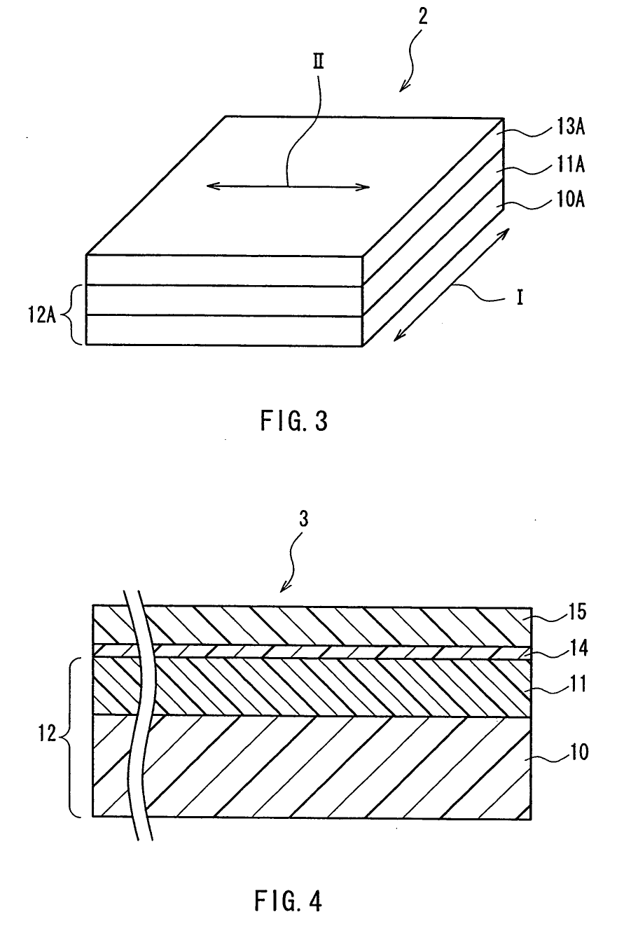

FIG. 3 is a perspective view of a retardation film produced in this Example. As shown in this figure, this retardation film 2 includes a base-attached optically anisotropic layer 12A containing a transparent base 10A and an optically anisotropic layer 11A, and an optical retardation layer 13A. In the figure, an arrow I denotes a stretch axis direction of the base-attached optically anisotropic layer 12A, and an arrow II denotes a polarization axis direction of the polarized ultraviolet light irradiated on the optical retardation layer 13A, and the both directions cross each other at right angles.

This retardation film 2 was produced in the following manner. First, a base-attached optically anisotropic layer was produced in the same manner as in Example 1, and was stretched by 10% its original length by a free-end uniaxial stretching at 150° C. in order to provide a base-attached optically anisotropic layer 12A having both the positive A-plate component and the C-plate component. Then, an incline-aligned retardation layer 13A was formed by the same operation as in Example 1 except that the polarized ultraviolet light was irradiated so that the polarization direction cross the stretch axis of the base-attached optically anisotropic layer 12A at right angles, thereby obtaining a retardation film 2.

### Comparative Example 1

FIG. 4 shows a cross-sectional view of a retardation film produced according to the Comparative Example. The retardation film 3 contains a transparent base 10, an optically anisotropic layer 11, an alignment film 14 and an optical retardation layer 15 laminated in this order, and the transparent base 10 and the optically anisotropic layer 11 form a base-attached anisotropic layer 12.

This retardation film 3 was produced in the following manner. First, the base-attached optically anisotropic layer 12 was prepared in the same manner as in Example 1. Next, on the surface of the optically anisotropic layer 11, a 2% cyclopentanone solution of a polymer that reacts with polarized ultraviolet light (trade name: LPP/F301CP manufactured by Vantico K.K.) was spin-coated at a rotational speed of 3000 rpm, and dried with heat at 130° C. for 10 minutes. This laminate, with its coated surface facing upward, was irradiated with polarized ultraviolet light (luminance of 6 mW/cm²) in the same manner as described in Example 1 and FIG. 2 except that the irradiation time was 1 second, thereby forming an optical alignment film 14 for liquid crystal inclination alignment.

Separately, a coating solution to make the retardation film 15 was prepared. That is, 0.01 g of a photoinitiator (trade name: Irgacure907 manufactured by Ciba Specialty Products) was added to 5 g of an ultraviolet polymeric nematic liquid crystalline compound (LCP/CB483CP manufactured by Vantico K.K.) and stirred for 10 minutes so as to obtain a coating solution.

Next, on the alignment film 14, the coating solution was spin-coated at a rotational speed of 1500 rpm, and dried with heat for 3 minutes at 110° C. This was kept uncontrolled for 3 minutes at room temperature, and subsequently the precursor layer was irradiated with unpolarized ultraviolet light so as to crosslink the liquid crystalline compound, thereby forming an optical retardation layer 15 so as to obtain the retardation film 3.

### Comparative Example 2

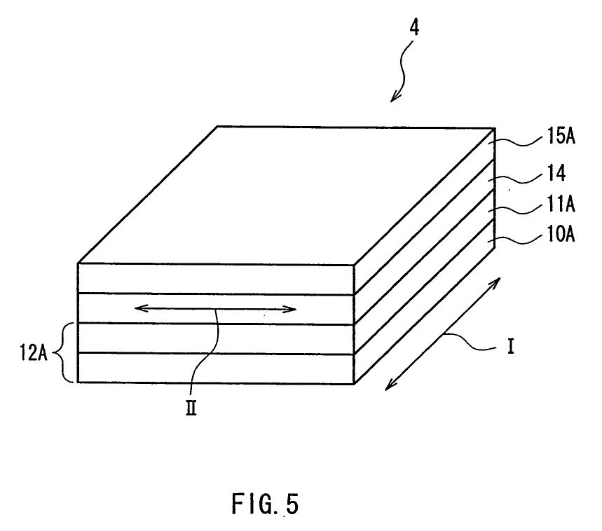

FIG. 5 is a perspective view showing a retardation film produced in this Comparative Example. As shown in the figure, this retardation film 4 includes a base-attached optically anisotropic layer 12A made of a transparent base 10A and an optically anisotropic layer 11A, an alignment film 14 and an optical retardation layer 15A. In this figure, an arrow I denotes a stretch axis direction for the base-attached optically anisotropic layer 12A, and an arrow II denotes a polarization axis direction of the polarized ultraviolet light irradiated on the optical retardation layer 15A, and the both directions cross each other at right angles.

The retardation film 4 was produced in the following manner. First, the base-attached optically anisotropic layer 12A was produced in the same manner as in Example 1. Then, the alignment film 14 was arranged on the optically anisotropic layer 12A in the same manner as Comparative Example 1 except that it was irradiated with polarized ultraviolet light such that the polarization direction crosses the stretch axis direction of the optically anisotropic layer 12A at right angles. Furthermore, the optical retardation layer 15A was formed in the same manner as in Comparative Example 1 so as to obtain the retardation film 4.

(Polarimetry)

Regarding the respective optical retardation layers and the optically anisotropic layers in the retardation films produced in Examples 1-2 and Comparative Example 1-2, polarimetry was performed by use of an ellipsometer (trade name: M220 type automatic wavelength scanning ellipsometer manufactured by JASCO Corporation).

Prior to the polarimetry, the optical retardation layers 13, 13A, 15 and 15A, and also the optically anisotropic layers 11, 11A in Examples 1-2 and Comparative Examples 1-2 were transferred separately on glass substrates so as to separate from the retardation films or the like, and thereby forming samples for measurement (polarimetry). This process will be specified below. For transferring of each of the optical retardation layers, first, a retardation film and a corresponding glass substrate were prepared. Next, an adhesive (acrylic adhesive agent manufactured by Nitto Denko Corporation) was applied onto the glass substrate and the surface applied with the adhesive and the surface of the optical retardation layer of the retardation film were brought into a close contact with each other. Then, the base of the retardation film and the optically anisotropic layer were peeled off and only the optical retardation layer was left on the glass substrate so as to complete the transferring, thereby obtaining a target sample for measurement. Transferring of the respective optically anisotropic layers was carried out similarly to the transferring of the respective optical retardation layers except that base-attached anisotropic layers free of optical retardation layers were used in place of the retardation films.

Furthermore, for each of the layers, the thickness was measured by use of a surface-shape meter (trade name: Surfcorder ET4000 manufactured by Kosaka Laboratory Ltd.). Specifically, a sample having a layer to be a subject of a thickness measurement on its surface was prepared. Next, a part of the layer was peeled off, and a thickness difference between the peeled part and the remaining part was measured with the surface-shape meter and the thus obtained value was set as the thickness.

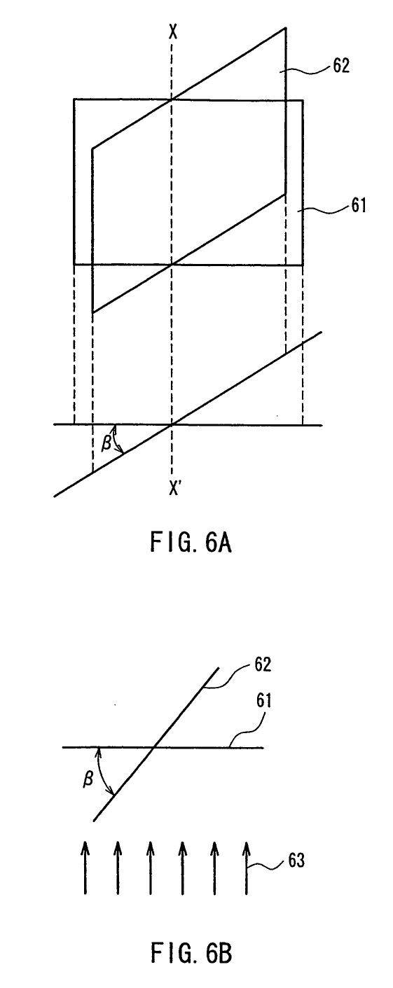

Polarimetry was carried out with the sample for measurement (polarimetry). The polarimetry will be described briefly below on the basis of the schematic views of FIGS. 6A and 6B. FIG. 6A is a perspective view schematically showing the polarimetry, FIG. 6B is the top view.

First, the respective elements shown in FIG. 6 will be described. In the figure, 61 denotes a measurement sample. Numeral 63 denotes incident light, and the incidence direction is perpendicular with respect to the face of the sample 61. An axis X-X′ crosses at right angles with a polarization axis of the polarized ultraviolet light irradiated during the production of the retardation film. That is, in Example 2 and in Comparative Example 2, the axis X-X′ is parallel to the stretch axis of the optically anisotropic layer. And numeral 62 denotes the sample 61 being rotated by an angle β about the axis X-X′. For the samples 61 and 62, expression of the thickness was omitted in the figures for convenience.

Polarimetry will be described briefly below. First, the measurement sample 61 was set such that the face was perpendicular with respect to the incidence direction of the incident light 63. Then, the incident light 63 was irradiated on the sample 61, and a retardation R (nm) was measured. For the sample 61, the retardation R can be expressed with the Formula (VI) below.
R=(nx−ny)×d (VI)

Here, ‘d’ denotes a thickness (nm) of a layer to be measured (e.g., an optical retardation layer), and the measurement is carried out in the above-mentioned manner. An average refractive index “(nx+ny+nz)/3” was measured separately, and nx, ny and nz were calculated from the measurement results and also from the thickness d and the retardation R. Here, the nx, ny and nz are defined as mentioned above, except that the Y-axis denotes an axis in a direction parallel to the axis X-X′, and the X-axis denotes an axis in a direction perpendicular to the Y-axis within the plane of the sample 61. The Z-axis denotes an axis parallel to the incidence direction of the incident light 63.

Next, the sample 61 was rotated by an arbitrary angle β about the axis X-X′. This angle β will be referred to as “a gate angle”. And the retardation R (nm) in the sample 62 in the state was measured. In the sample 62, the relationship between R, nx′, ny′ and d is expressed by the following Formulae (VII) and (VIII).
Δn=nx′−ny′ (VII)
R=Δnd (VIII)

In the formulae, nx′ denotes a refractive index in the X-axis direction in the sample 62, ny′ denotes a refractive index in the Y-axis direction in the sample 62, and d is identical to that of the Formula (VI).

Hereinafter, the retardation R was measured in the respective states while changing the gate angle β. Since the X- and Y-axes directions are fixed, when the gate angle β is changed, the Δn and R will be changed in accordance with the optical anisotropy of a layer to be measured.

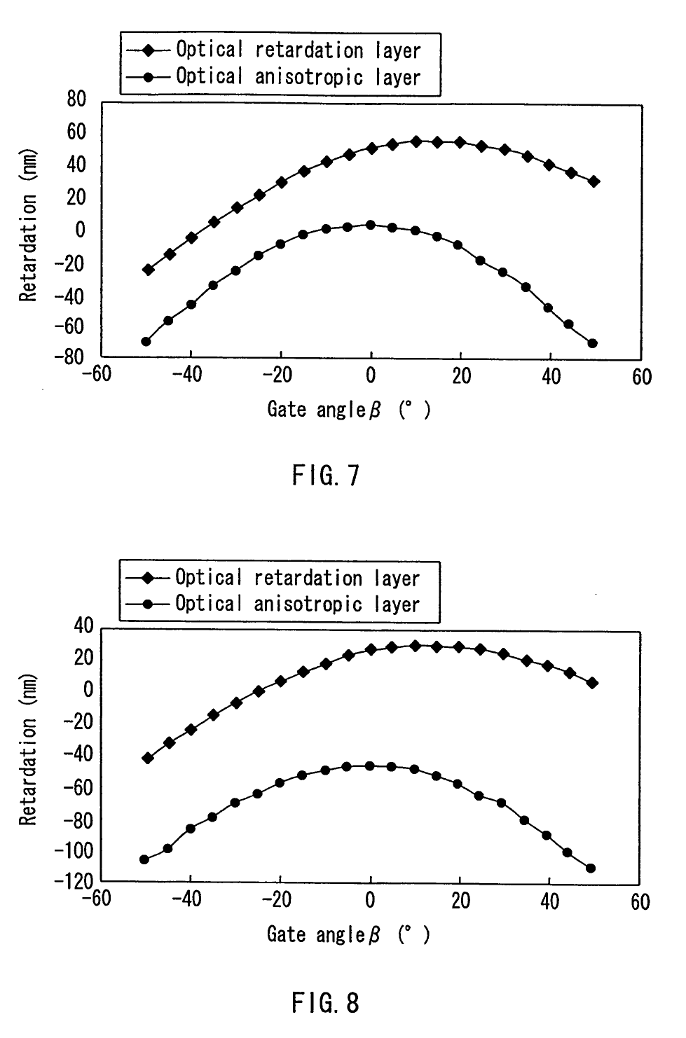

In this manner, for each of the optical retardation layers and the optically anisotropic layers, the gate angle was changed from −60° to 60° and the retardations for the respective gate angles were measured in order to express the relationship between the gate angle and the retardation in graphs. FIGS. 7-10 shows respectively the results obtained for Examples 1-2 and Comparative Example 1-2. For the optically anisotropic layers, since Comparative Example 1 and Comparative Example 2 are identical to Example 1 and Example 2 respectively, the optically anisotropic layers will be referred to only in Examples.

As shown in FIG. 7, the optically anisotropic layer 11 in Example 1 has a retardation of substantially 0 nm at a gate angle β=0°, and a symmetric change was observed about the gate angle β=0°. The nx, ny and nz for the optically anisotropic layer 11 were 1.560, 1.559 and 1.518 respectively. On the other hand, in the optical retardation layer 13 in Example 1, the retardation at the gate angle β=0° was not 0 nm, and the change about the gate angle β=0° became asymmetric. Therefore, the optically anisotropic layer 11 was a negative C-plate, and the optical retardation layer 13 formed on the optically anisotropic layer 11 was an O-plate where the nematic liquid crystal is incline-aligned.

As shown in FIG. 8, the optically anisotropic layer 11A of Example 2 exhibited a symmetric change about the gate angle β=0°, and the retardation with the gate angle β=0° was protruded toward the positive side. The nx, ny and nz were 1.555, 1.564 and 1.520 respectively. On the other hand, in the optical retardation layer 13A in the same Example 2, the change about the gate angle β=0° became asymmetric. This result shows that the uniaxially stretched optically anisotropic layer 11A has a biaxial anisotropy, i.e., it has both the positive A-plate component and a negative C-plate component. The retardation layer 13A was confirmed to be an O-plate which was inclined in a direction of an azimuth crossing with the stretch axis at right angles and also a thickness direction.

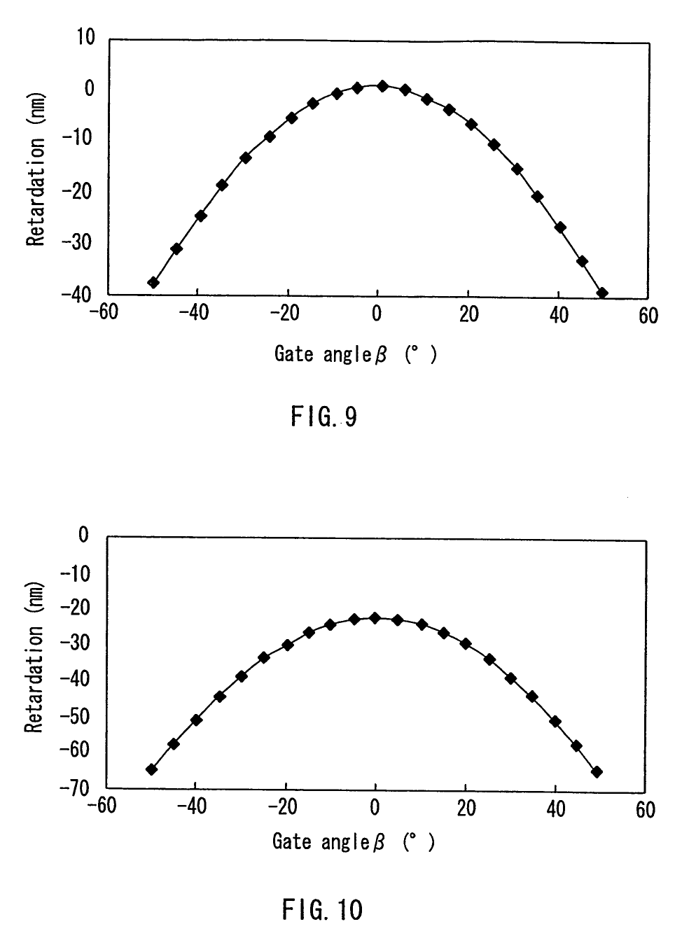

Furthermore, as shown in FIG. 9, the optical retardation layer 15 in the retardation film in Comparative Example 1 has a retardation of substantially 0 nm at a gate angle β=0°, and exhibited a symmetric retardation change about the gate angle β=0°. This result shows that the optical retardation layer 15 on the alignment film 14 did not have either an in-plane anisotropy or an inclination alignment property.

Furthermore, as shown in FIG. 10, the optical retardation layer 15A of the retardation film in Comparative Example 2 exhibited a symmetric retardation change about the gate angle β=0°. This result shows that the optical retardation layer 15A on the alignment film 14 did not have an inclination alignment property.

As indicated from the above measurement results, in each Example, a retardation film was produced by laminating directly an optical retardation layer on an optically anisotropic layer, without using an alignment film, alignment substrate or the like. On the other hand, in each Comparative Example, in spite of an endeavor of forming an optical retardation layer on an optically anisotropic layer via an alignment film, the alignment film failed to serve for the alignment, and as a result, the optical retardation layer failed to provide its inherent function of optical compensation.

### INDUSTRIAL APPLICABILITY

As mentioned above, the present invention provides a retardation film that has an optical retardation layer whose alignment direction is under a precise control and that can be produced at a low cost, and a method for producing the same. Since the retardation film of the present invention is formed by laminating an optical retardation layer directly on an optically anisotropic layer without interposing either an alignment film or an adhesive, the costs can be decreased for the alignment film or the adhesive. Moreover, due to absence of the alignment film, the adhesive and the like, a thinner retardation film with improved optical functions can be provided. According to the method for producing the retardation film of the present invention, since the optical retardation layer can be formed on the optically anisotropic layer without using an alignment film, an alignment substrate, an adhesive or the like, the cost for the material can be decreased. Furthermore, since steps of forming an alignment film and transferring the optical retardation layer can be omitted, production steps can be decreased for the steps, which results in improvement in the production efficiency and a further cost reduction.

1. A retardation film comprising an optically anisotropic layer and a retardation layer, the retardation layer comprising an aligned liquid crystalline compound,
wherein the optically anisotropic layer contains at least one material selected from the group consisting of polyamide, polyimide, polyester, poly(etherketone), poly(amide-imide), and poly(ester-imide),
the optically anisotropic layer is formed on a transparent base, and
the retardation layer is laminated directly on the optically anisotropic layer.

2. The retardation film according to claim 1, wherein the optical retardation layer further comprises an aligned polymer.

3. The retardation film according to claim 1, wherein the liquid crystalline compound has an alignment direction inclined with respect to a face direction of the optically anisotropic layer.

4. The retardation film according to claim 1, wherein the liquid crystalline compound has an alignment direction varying depending on a position in the thickness direction of the optical retardation layer.

5. The retardation film according to claim 1, wherein a vector component in a face direction of the optically anisotropic layer, which composes a vector in the alignment direction of the liquid crystalline compound, crosses at right angles an optical axis of the optically anisotropic layer.

6. The retardation film according to claim 1, wherein the optical retardation layer has a positive uniaxial refractive index anisotropy.

7. The retardation film according to claim 1, wherein the liquid crystalline compound has a crosslinking structure.

8. The retardation film according to claim 1, wherein the liquid crystalline compound comprises a nematic liquid crystalline compound.

9. The retardation film according to claim 1, wherein the optically anisotropic layer has a negative uniaxial refractive index anisotropy.

10. The retardation film according to claim 1, wherein the optically anisotropic layer has a biaxial refractive index anisotropy.

11. (canceled)

12. The retardation film according to claim 1, wherein the optically anisotropic layer comprises polyimide.

13. (canceled)

14. An optical element comprising the retardation film according to claim 1 and a polarizer.

15. The optical element according to claim 14, further comprising a transparent protective film, and the transparent protective film is sandwiched between the retardation film and the polarizer.

16. The optical element according to claim 14, wherein the polarizer is a stretched polymer film.

17. The optical element according to claim 14, wherein the polarizer is a polyvinyl alcohol-based polarizing film.

18. An image display apparatus comprising the retardation film according to claim 1.

19. A method for producing a retardation film, the method comprising steps of:
applying a solution containing at least one material selected from the group consisting of polyamide, polyimide, polyester, poly(etherketone), poly(amide-imide), and poly(ester-imide),
drying the solution so as to form an optically anisotropic layer,
applying a solution that contains a liquid crystalline compound and a polymer to react with polarized ultraviolet light, onto the optically anisotropic layer;
drying the solution so as to form a precursor layer of a retardation layer; and
irradiating a surface of the precursor layer with polarized ultraviolet light.

20. The method for producing a retardation film according to claim 19, further comprising a step of crosslinking the liquid crystalline compound.

21. The method for producing a retardation film according to claim 19, further comprising a step of irradiating the surface of the precursor layer with unpolarized ultraviolet light.

22. A method for producing an optical element, the method comprising steps of:
preparing a retardation film produced according to the producing method of claim 19 and a polarizer, and applying an adhesive onto at least either the retardation film or the polarizer;
drying the adhesive; and
bonding the retardation film and the polarizer via a surface applied with the adhesive.

23. A method for producing an optical element, the method comprising steps of:
preparing the retardation film produced according to the producing method of claim 19 and a polarizer having a transparent protective film adhered, and applying an adhesive onto at least either the retardation film or the transparent protective film;
drying the adhesive; and
bonding the retardation film and the transparent protective film via a surface applied with the adhesive.

24. A method for producing a retardation film according to claim 19, further comprising a step of stretching or shrinking the optically anisotropic layer together with the transparent base.

25. A method for producing a retardation film, the method comprising steps of:
stretching or shrinking an optically anisotropic layer together with a base on which the optically anisotropic layer is formed;
applying a solution that contains a liquid crystalline compound and a polymer that reacts with polarized ultraviolet light, onto the optically anisotropic layer;
drying the solution so as to form a precursor layer of a retardation layer; and
irradiating a surface of the precursor layer with polarized ultraviolet light.

26. The method for producing a retardation film according to claim 25, wherein the base is a transparent base.

27. The method for producing a retardation film according to claim 25, further comprising a step of crosslinking the liquid crystalline compound.

28. The method for producing a retardation film according to claim 25, further comprising a step of irradiating the surface of the precursor layer with unpolarized ultraviolet light.

29. A method for producing an optical element, the method comprising steps of:
preparing a retardation film produced by the method according to claim 25 and a polarizer, and applying an adhesive onto at least one of the retardation film and the polarizer;
drying the adhesive; and
bonding the retardation film and the polarizer via a surface applied with the adhesive.

30. A method for producing an optical element, the method comprising steps of:
preparing a retardation film produced by the method according to claim 25 and a polarizer to which a transparent protective film is adhered, and applying an adhesive onto at least one of the retardation film and the transparent protective film;
drying the adhesive; and
bonding the retardation film and the transparent protective film via a surface applied with the adhesive.

31. An image display apparatus comprising the optical element according to claim 14.
